(19) United States
(12) Patent Application Publication
(10) Pub. No.: US 2024/0338521 A1
(43) Pub. Date: Oct. 10, 2024

(54) INTELLIGENT HUMAN-IN-THE-LOOP VALIDATION DURING DOCUMENT EXTRACTION PROCESSING

(71) Applicant: Snowflake Inc., Bozeman, MT (US)

(72) Inventors: Michal Gdak, Warsaw (PL); Ganeshan Ramachandran Iyer, Redmond, WA (US); Tomasz Malisz, Bialystok (PL); Mikolaj Niedbala, Poznan (PL); Pawel Pollak, Warszawa (PL); Saurin Shah, Kirkland, WA (US); Jan Tomasz Topinski, Izabelin (PL)

(21) Appl. No.: 18/629,693

(22) Filed: Apr. 8, 2024

Related U.S. Application Data
(60) Provisional application No. 63/495,169, filed on Apr. 10, 2023.

(51) Int. Cl. G06F 40/226

(52) U.S. Cl. CPC G06F 40/226

(57) ABSTRACT

Systems and methods for: processing a current electronic document, using a set of machine-learning (ML) models, to extract a set of values for a set of data points based on a schema, where the schema describes the set of data points to be extracted from electronic documents; determining whether to select the current electronic document for human validation based on the schema; and adding the current electronic document to a human validation queue in response to determining to select the current electronic document for human validation based on the schema.

### CROSS REFERENCE TO RELATED APPLICATION

This application claims priority to and the benefit of U.S. Provisional Patent Application No. 63/495,169, filed on Apr. 10, 2023, which is incorporated herein by reference.

### TECHNICAL FIELD

Embodiments of the disclosure relate generally to electronic document processing and, more specifically, to intelligent (e.g., selective) human-in-the-loop validation of information extracted from one or more electronic documents by a process, such as a machine-learning (ML) model-based process, where the intelligent human-in-the-loop validation can be used with a document information extraction process that is continuously running (e.g., document information extraction pipeline).

### BACKGROUND

Individuals use various types of electronic documents (also referred to herein as “documents”) including scanned handwritten documents, scanned forms, large documents (reports), word processing documents (e.g., DOCX documents), postscript documents (e.g., PDF documents), and the like. Additionally, documents can sometimes be in the form of images (e.g., pictures of pages). A given user may want to process these and other document types and use a document process, such as a machine-learning (ML) model-based process, to extract data points from documents. For instance, the given user can set up a document processing pipeline that is configured to ingest (e.g., continuously ingest) multiple documents of various types and process each of the documents using one or more ML models to extract data points of interest to the given user.

### BRIEF DESCRIPTION OF THE DRAWINGS

The present disclosure will be understood more fully from the detailed description given below and from the accompanying drawings of various embodiments of the disclosure.

FIG. 1 illustrates an example computing environment that includes a network-based database system in communication with a cloud storage platform, according to some embodiments.

FIG. 2 is a diagram illustrating the components of a compute service manager, according to some embodiments.

FIG. 3 is a diagram illustrating components of an execution platform, according to some embodiments.

FIG. 4 is a flowchart of an example method for intelligent human-in-the-loop validation for information extracted from an electronic document, according to some embodiments.

FIG. 5 illustrates a diagrammatic representation of a machine in the form of a computer system within which a set of instructions may be executed for causing the machine to perform any one or more of the methodologies discussed herein, according to some embodiments.

### DETAILED DESCRIPTION

Reference will now be made in detail to specific embodiments for carrying out the inventive subject matter. Examples of these specific embodiments are illustrated in the accompanying drawings, and specific details are outlined in the following description to provide a thorough understanding of the subject matter. It will be understood that these examples are not intended to limit the scope of the claims to the illustrated embodiments. On the contrary, they are intended to cover such alternatives, modifications, and equivalents as may be included within the scope of the disclosure.

Generally, ML models are not guaranteed to generate accurate results, and in the context of document processing, this can result in inaccurate data extraction. To mitigate/address this issue, users who desire a high level of accuracy during document data extraction can use human-in-the-loop validation with an ML model. Unfortunately, when processing large amounts of documents (or during continuous document processing), human validators usually do not have bandwidth to validate all documents.

Various embodiments described herein provide for systems, methods, devices, instructions, and like for intelligent (e.g., selective) human-in-the-loop validation of information extracted from one or more electronic documents by a process (e.g., machine-learning (ML) model-based process), where the intelligent human-in-the-loop validation can be used with a document information extraction process that is continuously running. Some embodiments described herein can be useful for validating information extracted from a large plurality (e.g., batch) of electronic documents, or validating extracted information that is provided (e.g., in real time or continuously) from a document information extraction pipeline, which can receive and process documents in real-time. Individual elements of information that are targeted for extraction from an electronic document can be referred to as data points, and the extracted values for those data points can be referred to as data point values. For some embodiments, data points extracted from electronic documents are stored into a table (e.g., of a data platform), such as a database table, where extracted values for the data points can be stored in columns of the table according to data point-to-column mapping. Use of various embodiments can, for example, provide for intelligent selection of certain electronic documents for human validation (as described herein), where those certain electronic documents, when processed by a ML model for extraction of one or more data points, result in the ML model providing (e.g., indicating) low confidence scores for one or more data point values extracted. As used herein, an electronic document can comprise a file. For some embodiments, a ML model comprises a large-language model (LLM).

In the present disclosure, physical units of data that are stored in a data platform—and that make up the content of, e.g., database tables in customer accounts—are referred to as micro-partitions. In different implementations, a data platform may store metadata in micro-partitions as well. The term “micro-partitions” is distinguished in this disclosure from the term “files,” which, as used herein, refers to data units such as image files (e.g., Joint Photographic Experts Group (JPEG) files, Portable Network Graphics (PNG) files, etc.), video files (e.g., Moving Picture Experts Group (MPEG) files, MPEG-4 (MP4) files, Advanced Video Coding High Definition (AVCHD) files, etc.), Portable Document Format (PDF) files, electronic documents that are formatted to be compatible with one or more word-processing applications, electronic documents that are formatted to be compatible with one or more spreadsheet applications, and/or the like. If stored internal to the data platform, a given file is referred to herein as an “internal file” and may be stored in (or at, or on, etc.) what is referred to herein as an “internal storage location.” If stored external to the data platform, a given file is referred to herein as an “external file” and is referred to as being stored in (or at, or on, etc.) what is referred to herein as an “external storage location.” These terms are further discussed below.

Computer-readable files come in several varieties, including unstructured files, semi-structured files, and structured files. These terms may mean different things to different people. As used herein, examples of unstructured files include image files, video files, PDFs, audio files, and the like; examples of semi-structured files include JavaScript Object Notation (JSON) files, extensible Markup Language (XML) files, and the like; and examples of structured files include Variant Call Format (VCF) files, Keithley Data File (KDF) files, Hierarchical Data Format version 5 (HDF5) files, and the like. As known to those of skill in the relevant arts, VCF files are often used in the bioinformatics field for storing, e.g., gene-sequence variations, KDF files are often used in the semiconductor industry for storing, e.g., semiconductor-testing data, and HDF5 files are often used in industries such as the aeronautics industry, in that case for storing data such as aircraft-emissions data. Numerous other example unstructured-file types, semi-structured-file types, and structured-file types, as well as example uses thereof, could certainly be listed here as well and will be familiar to those of skill in the relevant arts. Different people of skill in the relevant arts may classify types of files differently among these categories and may use one or more different categories instead of or in addition to one or more of these.

Data platforms are widely used for data storage and data access in computing and communication contexts. Concerning architecture, a data platform could be an on-premises data platform, a network-based data platform (e.g., a cloud-based data platform), a combination of the two, and/or include another type of architecture. Concerning the type of data processing, a data platform could implement online analytical processing (OLAP), online transactional processing (OLTP), a combination of the two, and/or another type of data processing. Moreover, a data platform could be or include a relational database management system (RDBMS) and/or one or more other types of database management systems.

In a typical implementation, a data platform may include one or more databases that are respectively maintained in association with any number of customer accounts (e.g., accounts of one or more data providers), as well as one or more databases associated with a system account (e.g., an administrative account) of the data platform, one or more other databases used for administrative purposes, and/or one or more other databases that are maintained in association with one or more other organizations and/or for any other purposes. A data platform may also store metadata (e.g., account object metadata) in association with the data platform in general and in association with, for example, particular databases and/or particular customer accounts as well. Users and/or executing processes that are associated with a given customer account may, via one or more types of clients, be able to cause data to be ingested into the database, and may also be able to manipulate the data, add additional data, remove data, run queries against the data, generate views of the data, and so forth. As used herein, the terms “account object metadata” and “account object” are used interchangeably.

In an implementation of a data platform, a given database (e.g., a database maintained for a customer account) may reside as an object within, e.g., a customer account, which may also include one or more other objects (e.g., users, roles, grants, shares, warehouses, resource monitors, integrations, network policies, and/or the like). Furthermore, a given object, such as a database, may itself contain one or more objects, such as schemas, tables, materialized views, and/or the like. A given table may be organized as a collection of records (e.g., rows) so that each includes a plurality of attributes (e.g., columns). In some implementations, database data is physically stored across multiple storage units, which may be referred to as files, blocks, partitions, micro-partitions, and/or by one or more other names. In many cases, a database on a data platform serves as a backend for one or more applications that are executing on one or more application servers.

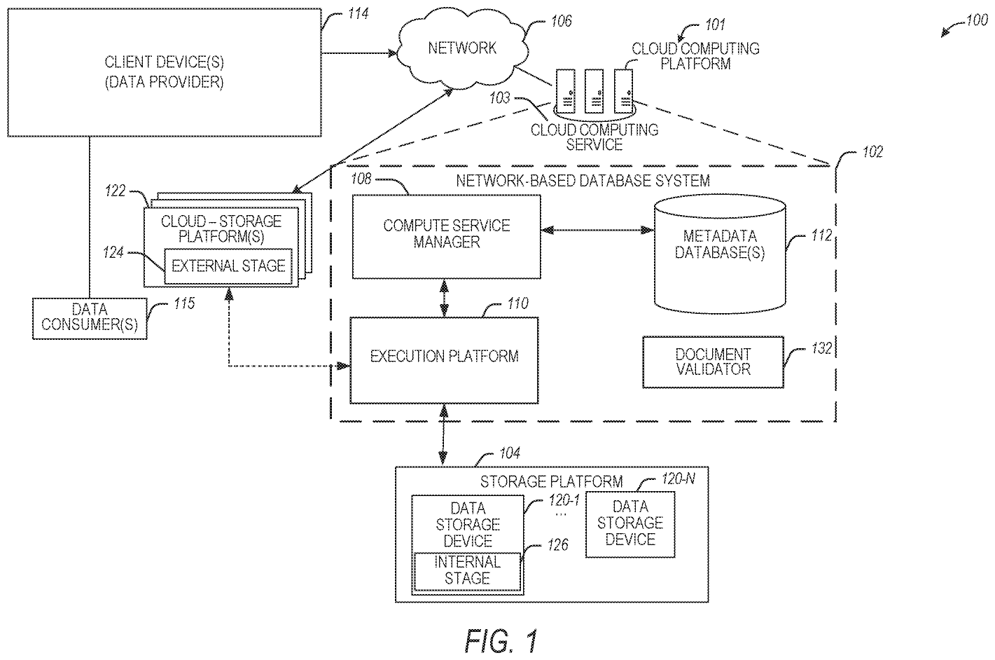

FIG. 1 illustrates an example computing environment 100 that includes a database system in the example form of a network-based database system 102, according to some embodiments. To avoid obscuring the inventive subject matter with unnecessary detail, various functional components that are not germane to conveying an understanding of the inventive subject matter have been omitted from FIG. 1. However, a skilled artisan will readily recognize that various additional functional components may be included as part of the computing environment 100 to facilitate additional functionality that is not specifically described herein. In other embodiments, the computing environment may comprise another type of network-based database system or a cloud data platform. For example, in some embodiments, the computing environment 100 may include a cloud computing platform 101 with the network-based database system 102, and a storage platform 104 (also referred to as a cloud storage platform). The cloud computing platform 101 provides computing resources and storage resources that may be acquired (purchased) or leased and configured to execute applications and store data.

The cloud computing platform 101 may host a cloud computing service 103 that facilitates storage of data on the cloud computing platform 101 (e.g., data management and access) and analysis functions (e.g., SQL queries, analysis), as well as other processing capabilities (e.g., configuring replication group objects as described herein). The cloud computing platform 101 may include a three-tier architecture: data storage (e.g., storage platforms 104 and 122), an execution platform 110 (e.g., providing query processing), and a compute service manager 108 providing cloud services.

It is often the case that organizations that are customers of a given data platform also maintain data storage (e.g., a data lake) that is external to the data platform (i.e., one or more external storage locations). For example, a company could be a customer of a particular data platform and also separately maintain storage of any number of files—be they unstructured files, semi-structured files, structured files, and/or files of one or more other types—on, as examples, one or more of their servers and/or on one or more cloud-storage platforms such as AMAZON WEB SERVICES™ (AWS™), MICROSOFT® AZURE®, GOOGLE CLOUD PLATFORM™, and/or the like. The customer's servers and cloud-storage platforms are both examples of what a given customer could use as what is referred to herein as an external storage location. The cloud computing platform 101 could also use a cloud-storage platform as what is referred to herein as an internal storage location concerning the data platform.

From the perspective of the network-based database system 102 of the cloud computing platform 101, one or more files that are stored at one or more storage locations are referred to herein as being organized into one or more of what is referred to herein as either “internal stages” or “external stages.” Internal stages are stages that correspond to data storage at one or more internal storage locations, and where external stages are stages that correspond to data storage at one or more external storage locations. In this regard, external files can be stored in external stages at one or more external storage locations, and internal files can be stored in internal stages at one or more internal storage locations, which can include servers managed and controlled by the same organization (e.g., company) that manages and controls the data platform, and which can instead or in addition include data-storage resources operated by a storage provider (e.g., a cloud-storage platform) that is used by the data platform for its “internal” storage. The internal storage of a data platform is also referred to herein as the “storage platform” of the data platform. It is further noted that a given external file that a given customer stores at a given external storage location may or may not be stored in an external stage in the external storage location—i.e., in some data-platform implementations, it is a customer's choice whether to create one or more external stages (e.g., one or more external-stage objects) in the customer's data-platform account as an organizational and functional construct for conveniently interacting via the data platform with one or more external files.

As shown, the network-based database system 102 of the cloud computing platform 101 is in communication with the cloud storage platforms 104 and 122 (e.g., AWS®, Microsoft Azure Blob Storage®, or Google Cloud Storage). The network-based database system 102 is a network-based system used for reporting and analysis of integrated data from one or more disparate sources including one or more storage locations within the cloud storage platform 104. The cloud storage platform 104 comprises a plurality of computing machines and provides on-demand computer system resources such as data storage and computing power to the network-based database system 102.

The network-based database system 102 comprises a compute service manager 108, an execution platform 110, and one or more metadata databases 112. The network-based database system 102 hosts and provides data reporting and analysis services to multiple client accounts.

The compute service manager 108 coordinates and manages operations of the network-based database system 102. The compute service manager 108 also performs query optimization and compilation as well as managing clusters of computing services that provide compute resources (also referred to as “virtual warehouses”). The compute service manager 108 can support any number of client accounts such as end-users providing data storage and retrieval requests, system administrators managing the systems and methods described herein, and other components/devices that interact with compute service manager 108.

The compute service manager 108 is also in communication with a client device 114. The client device 114 corresponds to a user of one of the multiple client accounts supported by the network-based database system 102. A user may utilize the client device 114 to submit data storage, retrieval, and analysis requests to the compute service manager 108. Client device 114 (also referred to as remote computing device or user device 114) may include one or more of a laptop computer, a desktop computer, a mobile phone (e.g., a smartphone), a tablet computer, a cloud-hosted computer, cloud-hosted serverless processes, or other computing processes or devices may be used (e.g., by a data provider) to access services provided by the cloud computing platform 101 (e.g., cloud computing service 103) by way of a network 106, such as the Internet or a private network. A data consumer 115 can use another computing device to access the data of the data provider (e.g., data obtained via the client device 114).

In the description below, actions are ascribed to users, particularly consumers and providers. Such actions shall be understood to be performed concerning client device (or devices) 114 operated by such users. For example, a notification to a user may be understood to be a notification transmitted to the client device 114, input or instruction from a user may be understood to be received by way of the client device 114, and interaction with an interface by a user shall be understood to be interaction with the interface on the client device 114. In addition, database operations (joining, aggregating, analysis, etc.) ascribed to a user (consumer or provider) shall be understood to include performing such actions by the cloud computing service 103 in response to an instruction from that user.

The compute service manager 108 is also coupled to one or more metadata databases 112 that store metadata about various functions and aspects associated with the network-based database system 102 and its users. For example, a metadata database 112 may include a summary of data stored in remote data storage systems as well as data available from a local cache. Additionally, a metadata database 112 may include information regarding how data is organized in remote data storage systems (e.g., the cloud storage platform 104) and the local caches. Information stored by a metadata database 112 allows systems and services to determine whether a piece of data needs to be accessed without loading or accessing the actual data from a storage device. In some embodiments, metadata database 112 is configured to store account object metadata (e.g., account objects used in connection with a replication group object).

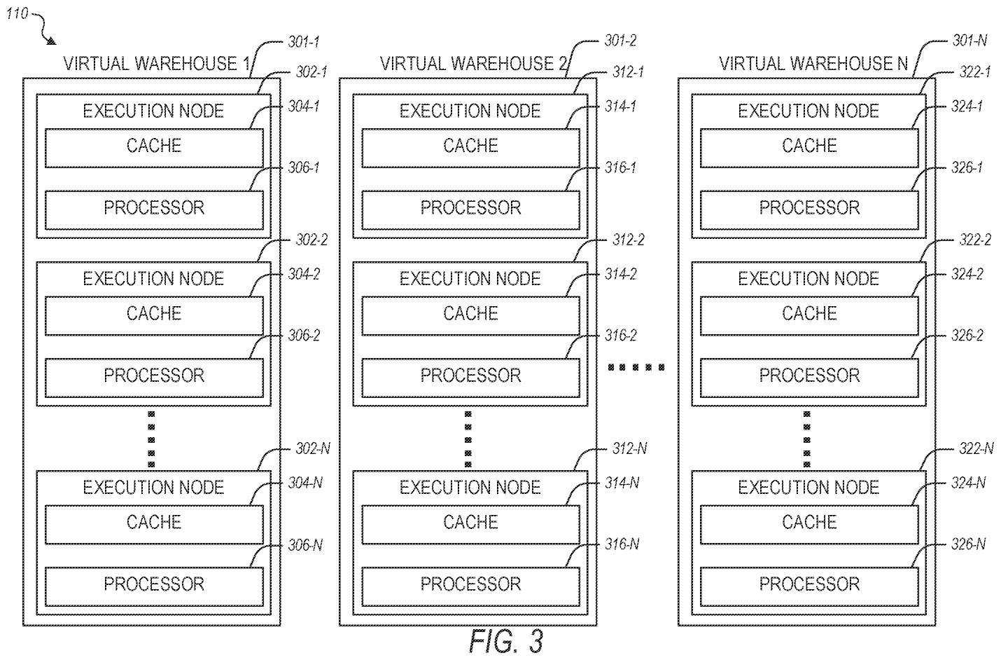

The compute service manager 108 is further coupled to the execution platform 110, which provides multiple computing resources that execute various data storage and data retrieval tasks. As illustrated in FIG. 3, the execution platform 110 comprises a plurality of compute nodes. The execution platform 110 is coupled to storage platform 104 and cloud storage platforms 122. The storage platform 104 comprises multiple data storage devices 120-1 to 120-N. In some embodiments, the data storage devices 120-1 to 120-N are cloud-based storage devices located in one or more geographic locations. For example, the data storage devices 120-1 to 120-N may be part of a public cloud infrastructure or a private cloud infrastructure. The data storage devices 120-1 to 120-N may be hard disk drives (HDDs), solid-state drives (SSDs), storage clusters, Amazon S3™ storage systems, or any other data-storage technology. Additionally, the cloud storage platform 104 may include distributed file systems (such as Hadoop Distributed File Systems (HDFS)), object storage systems, and the like. In some embodiments, at least one internal stage 126 may reside on one or more of the data storage devices 120-1-120-N, and at least one external stage 124 may reside on one or more of the cloud storage platforms 122.

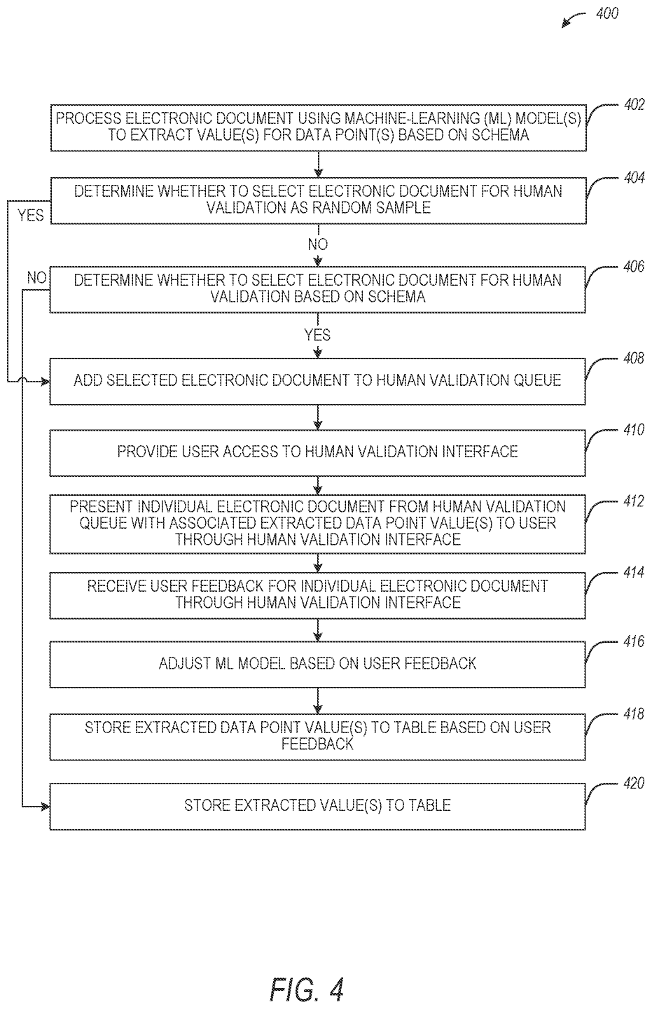

In some embodiments, the network-based database system 102 includes the document validator 132. The document validator 132 comprises suitable circuitry, interfaces, logic, and/or code and is configured to provide intelligent (e.g., selective) human-in-the-loop validation of information (e.g., data point values) extracted from one or more electronic documents by a process (e.g., machine-learning (ML) model-based process). In some embodiments, the document validator 132 can include one or more system functions that can be used to implement a method of human-in-the-loop validation as described herein. More regarding example methods are described herein with respect to FIG. 4.

In some embodiments, communication links between elements of the computing environment 100 are implemented via one or more data communication networks. These data communication networks may utilize any communication protocol and any type of communication medium. In some embodiments, the data communication networks are a combination of two or more data communication networks (or sub-Networks) coupled to one another. In alternate embodiments, these communication links are implemented using any type of communication medium and any communication protocol.

The compute service manager 108, metadata database(s) 112, execution platform 110, and storage platform 104, are shown in FIG. 1 as individual discrete components. However, each of the compute service manager 108, metadata database(s) 112, execution platform 110, and storage platform 104 may be implemented as a distributed system (e.g., distributed across multiple systems/platforms at multiple geographic locations). Additionally, each of the compute service manager 108, metadata database(s) 112, execution platform 110, and storage platform 104 can be scaled up or down (independently of one another) depending on changes to the requests received and the changing needs of the network-based database system 102. Thus, in the described embodiments, the network-based database system 102 is dynamic and supports regular changes to meet the current data processing needs.

During a typical operation, the network-based database system 102 processes multiple jobs determined by the compute service manager 108. These jobs are scheduled and managed by the compute service manager 108 to determine when and how to execute the job. For example, the compute service manager 108 may divide the job into multiple discrete tasks and may determine what data is needed to execute each of the multiple discrete tasks. The compute service manager 108 may assign each of the multiple discrete tasks to one or more nodes of the execution platform 110 to process the task. The compute service manager 108 may determine what data is needed to process a task and further determine which nodes within the execution platform 110 are best suited to process the task. Some nodes may have already cached the data needed to process the task and, therefore, be a good candidate for processing the task. Metadata stored in a metadata database 112 assists the compute service manager 108 in determining which nodes in the execution platform 110 have already cached at least a portion of the data needed to process the task. One or more nodes in the execution platform 110 process the task using data cached by the nodes and, if necessary, data retrieved from the cloud storage platform 104. It is desirable to retrieve as much data as possible from caches within the execution platform 110 because the retrieval speed is typically much faster than retrieving data from the cloud storage platform 104.

As shown in FIG. 1, the cloud computing platform 101 of the computing environment 100 separates the execution platform 110 from the storage platform 104. In this arrangement, the processing resources and cache resources in the execution platform 110 operate independently of the data storage devices 120-1 to 120-N in the cloud storage platform 104. Thus, the computing resources and cache resources are not restricted to specific data storage devices 120-1 to 120-N. Instead, all computing resources and all cache resources may retrieve data from, and store data to, any of the data storage resources in the cloud storage platform 104.

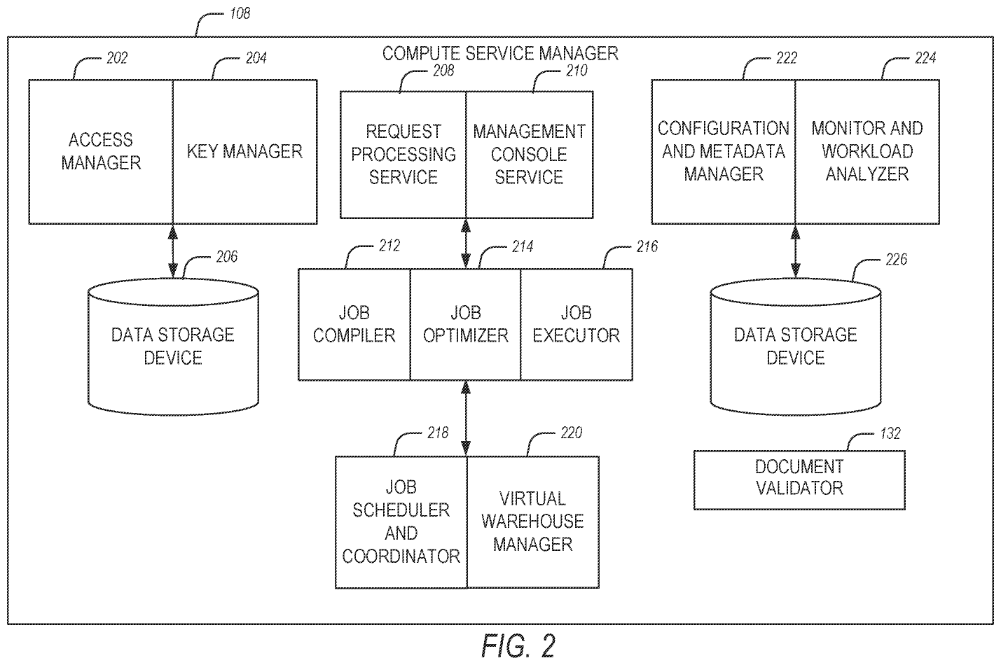

FIG. 2 is a block diagram illustrating components of the compute service manager 108, according to some embodiments. As shown in FIG. 2, the compute service manager 108 includes an access manager 202 and a key manager 204 coupled to an access metadata database 206, which is an example of the metadata database(s) 112. Access manager 202 handles authentication and authorization tasks for the systems described herein. The key manager 204 facilitates the use of remotely stored credentials to access external resources such as data resources in a remote storage device. As used herein, the remote storage devices may also be referred to as “persistent storage devices” or “shared storage devices.” For example, the key manager 204 may create and maintain remote credential store definitions and credential objects (e.g., in the access metadata database 206). A remote credential store definition identifies a remote credential store and includes access information to access security credentials from the remote credential store. A credential object identifies one or more security credentials using non-sensitive information (e.g., text strings) that are to be retrieved from a remote credential store for use in accessing an external resource. When a request invoking an external resource is received at run time, the key manager 204 and access manager 202 use information stored in the access metadata database 206 (e.g., a credential object and a credential store definition) to retrieve security credentials used to access the external resource from a remote credential store.

A request processing service 208 manages received data storage requests and data retrieval requests (e.g., jobs to be performed on database data). For example, the request processing service 208 may determine the data to process a received query (e.g., a data storage request or data retrieval request). The data may be stored in a cache within the execution platform 110 or in a data storage device in storage platform 104.

A management console service 210 supports access to various systems and processes by administrators and other system managers. Additionally, the management console service 210 may receive a request to execute a job and monitor the workload on the system.

The compute service manager 108 also includes a job compiler 212, a job optimizer 214, and a job executor 216. The job compiler 212 parses a job into multiple discrete tasks and generates the execution code for each of the multiple discrete tasks. The job optimizer 214 determines the best method to execute the multiple discrete tasks based on the data that needs to be processed. Job optimizer 214 also handles various data pruning operations and other data optimization techniques to improve the speed and efficiency of executing the job. The job executor 216 executes the execution code for jobs received from a queue or determined by the compute service manager 108.

A job scheduler and coordinator 218 sends received jobs to the appropriate services or systems for compilation, optimization, and dispatch to the execution platform 110. For example, jobs may be prioritized and then processed in that prioritized order. In an embodiment, the job scheduler and coordinator 218 determines a priority for internal jobs that are scheduled by the compute service manager 108 with other “outside” jobs such as user queries that may be scheduled by other systems in the database but may utilize the same processing resources in the execution platform 110. In some embodiments, the job scheduler and coordinator 218 identifies or assigns particular nodes in the execution platform 110 to process particular tasks. A virtual warehouse manager 220 manages the operation of multiple virtual warehouses implemented in the execution platform 110. For example, the virtual warehouse manager 220 may generate query plans for executing received queries.

Additionally, the compute service manager 108 includes configuration and metadata manager 222, which manages the information related to the data stored in the remote data storage devices and the local buffers (e.g., the buffers in execution platform 110). Configuration and metadata manager 222 uses metadata to determine which data files need to be accessed to retrieve data for processing a particular task or job. A monitor and workload analyzer 224 oversees processes performed by the compute service manager 108 and manages the distribution of tasks (e.g., workload) across the virtual warehouses and execution nodes in the execution platform 110. The monitor and workload analyzer 224 also redistributes tasks, as needed, based on changing workloads throughout the network-based database system 102 and may further redistribute tasks based on a user (e.g., “external”) query workload that may also be processed by the execution platform 110. The configuration and metadata manager 222 and the monitor and workload analyzer 224 are coupled to a data storage device 226. The data storage device 226 in FIG. 2 represents any data storage device within the network-based database system 102. For example, data storage device 226 may represent buffers in execution platform 110, storage devices in storage platform 104, or any other storage device.

As described in embodiments herein, the compute service manager 108 validates all communication from an execution platform (e.g., the execution platform 110) to validate that the content and context of that communication are consistent with the task(s) known to be assigned to the execution platform. For example, an instance of the execution platform executing query A should not be allowed to request access to data source D (e.g., data storage device 226) that is not relevant to query A. Similarly, a given execution node (e.g., execution node 302-1 may need to communicate with another execution node (e.g., execution node 302-2), and should be disallowed from communicating with a third execution node (e.g., execution node 312-1) and any such illicit communication can be recorded (e.g., in a log or other location). Also, the information stored on a given execution node is restricted to data relevant to the current query and any other data is unusable, rendered so by destruction or encryption where the key is unavailable.

As previously mentioned, the compute service manager 108 includes the document validator 132 configured to perform the human-in-the-loop validation functionalities, which are further discussed herein with respect to least FIG. 4.

FIG. 3 is a block diagram illustrating components of the execution platform 110, according to some embodiments. As shown in FIG. 3, the execution platform 110 includes multiple virtual warehouses, including virtual warehouse 1 (or 301-1), virtual warehouse 2 (or 301-2), and virtual warehouse N (or 301-N). Each virtual warehouse includes multiple execution nodes that each include a data cache and a processor. The virtual warehouses can execute multiple tasks in parallel by using multiple execution nodes. As discussed herein, the execution platform 110 can add new virtual warehouses and drop existing virtual warehouses in real-time based on the current processing needs of the systems and users. This flexibility allows the execution platform 110 to quickly deploy large amounts of computing resources when needed without being forced to continue paying for those computing resources when they are no longer needed. All virtual warehouses can access data from any data storage device (e.g., any storage device in the cloud storage platform 104).

Although each virtual warehouse shown in FIG. 3 includes three execution nodes, a particular virtual warehouse may include any number of execution nodes. Further, the number of execution nodes in a virtual warehouse is dynamic, such that new execution nodes are created when additional demand is present, and existing execution nodes are deleted when they are no longer necessary.

Each virtual warehouse is capable of accessing any of the data storage devices 120-1 to 120-N shown in FIG. 1. Thus, the virtual warehouses are not necessarily assigned to a specific data storage device 120-1 to 120-N and, instead, can access data from any of the data storage devices 120-1 to 120-N within the cloud storage platform 104. Similarly, each of the execution nodes shown in FIG. 3 can access data from any of the data storage devices 120-1 to 120-N. In some embodiments, a particular virtual warehouse or a particular execution node may be temporarily assigned to a specific data storage device, but the virtual warehouse or execution node may later access data from any other data storage device.

In the example of FIG. 3, virtual warehouse 1 includes three execution nodes 302-1, 302-2, and 302-N. Execution node 302-1 includes a cache 304-1 and a processor 306-1. Execution node 302-2 includes a cache 304-2 and a processor 306-2. Execution node 302-N includes a cache 304-N and a processor 306-N. Each execution node 302-1, 302-2, and 302-N is associated with processing one or more data storage and/or data retrieval tasks. For example, a virtual warehouse may handle data storage and data retrieval tasks associated with an internal service, such as a clustering service, a materialized view refresh service, a file compaction service, a storage procedure service, or a file upgrade service. In other implementations, a particular virtual warehouse may handle data storage and data retrieval tasks associated with a particular data storage system or a particular category of data.

Similar to virtual warehouse 1 discussed above, virtual warehouse 2 includes three execution nodes 312-1, 312-2, and 312-N. Execution node 312-1 includes a cache 314-1 and a processor 316-1. Execution node 312-2 includes a cache 314-2 and a processor 316-2. Execution node 312-N includes a cache 314-N and a processor 316-N. Additionally, virtual warehouse 3 includes three execution nodes 322-1, 322-2, and 322-N. Execution node 322-1 includes a cache 324-1 and a processor 326-1. Execution node 322-2 includes a cache 324-2 and a processor 326-2. Execution node 322-N includes a cache 324-N and a processor 326-N.

In some embodiments, the execution nodes shown in FIG. 3 are stateless with respect to the data being cached by the execution nodes. For example, these execution nodes do not store or otherwise maintain state information about the execution node or the data being cached by a particular execution node. Thus, in the event of an execution node failure, the failed node can be transparently replaced by another node. Since there is no state information associated with the failed execution node, the new (replacement) execution node can easily replace the failed node without concern for recreating a particular state.

Although the execution nodes shown in FIG. 3 each includes one data cache and one processor, alternative embodiments may include execution nodes containing any number of processors and any number of caches. Additionally, the caches may vary in size among the different execution nodes. The caches shown in FIG. 3 store, in the local execution node, data that was retrieved from one or more data storage devices in the cloud storage platform 104. Thus, the caches reduce or eliminate the bottleneck problems occurring in platforms that consistently retrieve data from remote storage systems. Instead of repeatedly accessing data from the remote storage devices, the systems and methods described herein access data from the caches in the execution nodes, which is significantly faster and avoids the bottleneck problem discussed above. In some embodiments, the caches are implemented using high-speed memory devices that provide fast access to the cached data. Each cache can store data from any of the storage devices in the cloud storage platform 104.

Further, the cache resources and computing resources may vary between different execution nodes. For example, one execution node may contain significant computing resources and minimal cache resources, making the execution node useful for tasks that require significant computing resources. Another execution node may contain significant cache resources and minimal computing resources, making this execution node useful for tasks that require caching of large amounts of data. Yet another execution node may contain cache resources providing faster input-output operations, useful for tasks that require fast scanning of large amounts of data. In some embodiments, the cache resources and computing resources associated with a particular execution node are determined when the execution node is created, based on the expected tasks to be performed by the execution node.

Although virtual warehouses 1, 2, and N are associated with the same execution platform 110, virtual warehouses 1, . . . , N may be implemented using multiple computing systems at multiple geographic locations. For example, virtual warehouse 1 can be implemented by a computing system at a first geographic location, while virtual warehouses 2 and N are implemented by another computing system at a second geographic location. In some embodiments, these different computing systems are cloud-based computing systems maintained by one or more different entities.

Additionally, each virtual warehouse is shown in FIG. 3 as having multiple execution nodes. The multiple execution nodes associated with each virtual warehouse may be implemented using multiple computing systems at multiple geographic locations. For example, an instance of virtual warehouse 1 implements execution nodes 302-1 and 302-2 on one computing platform at a geographic location, and execution node 302-N at a different computing platform at another geographic location. Selecting particular computing systems to implement an execution node may depend on various factors, such as the level of resources needed for a particular execution node (e.g., processing resource requirements and cache requirements), the resources available at particular computing systems, communication capabilities of networks within a geographic location or between geographic locations, and which computing systems are already implementing other execution nodes in the virtual warehouse.

Execution platform 110 is also fault-tolerant. For example, if one virtual warehouse fails, that virtual warehouse is quickly replaced with a different virtual warehouse at a different geographic location.

A particular execution platform 110 may include any number of virtual warehouses. Additionally, the number of virtual warehouses in a particular execution platform is dynamic, such that new virtual warehouses are created when additional processing and/or caching resources are needed. Similarly, existing virtual warehouses may be deleted when the resources associated with the virtual warehouse are no longer necessary.

In some embodiments, the virtual warehouses may operate on the same data in the cloud storage platform 104, but each virtual warehouse has its execution nodes with independent processing and caching resources. This configuration allows requests on different virtual warehouses to be processed independently and with no interference between the requests. This independent processing, combined with the ability to dynamically add and remove virtual warehouses, supports the addition of new processing capacity for new users without impacting the performance observed by the existing users.

In some embodiments, table data can be divided into one or more micro-partitions, which are contiguous units of storage.

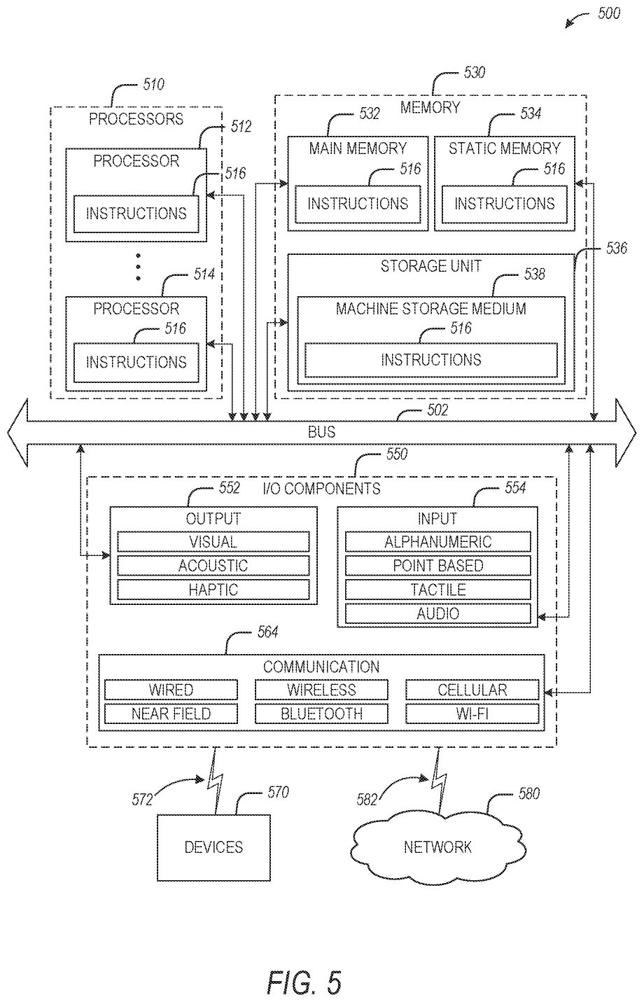

FIG. 4 is a flowchart of an example method 400 for intelligent human-in-the-loop validation for information extracted from an electronic document, according to some embodiments. Method 400 may be embodied in computer-readable instructions for execution by one or more hardware components (e.g., one or more processors) such that the operations of method 400 can be performed by components of the network-based database system 102, such as a network node (e.g., the document validator 132 executing on a network node of the compute service manager 108) or a computing device (e.g., client device 114), one or both of which may be implemented as machine 500 of FIG. 5 performing the disclosed functions. Accordingly, method 400 is described below, by way of example with reference thereto. However, it shall be appreciated that method 400 may be deployed on various other hardware configurations and is not intended to be limited to deployment within the network-based database system 102.

At operation 402, one or more hardware processors process an electronic document using a set of ML models to extract a set of values from the electronic document for a set of data points based on a schema (e.g., described or defined by the schema). The electronic document can comprise unstructured data, and the electronic document is being processed to extract values of the set of data points (e.g., structured data) from the unstructured data. The schema can describe (e.g., define) one or more parameters for extracting information from electronic documents using the set of ML models. For instance, the schema can describe (e.g., define) one or more of the following: one or more data points (e.g., structure of data points) to be extracted from a given electronic document; data types of data points; a set of acceptable confidence level thresholds (e.g., for confidence level or score provided by the set of ML models) for the one or more data points extracted from the given electronic document; a set of rules (e.g., regex rules) for the one or more data point values extracted from the given electronic document; a random sample value (e.g., seed value) for when human validation can randomly be invoked with respect to any electronic document that is being processed based on the schema; and one or more user interface elements of a human validation interface used for human validation any electronic document that is being processed based on the schema. Accordingly, the schema can define what information is to be extracted from electronic documents by the set of ML models. For some embodiments, the schema determines at least part of the structure of a table that receives (e.g., ingests) the data point values extracted from electronic documents processed by the set of ML models. For some embodiments, the schema is defined using a JavaScript Object Notation (JSON) schema. Additionally, for some embodiments, at least some portion of the schema can be defined (e.g., populated) based on an exploration or training process, where a user can ask questions relating to a training set of electronic documents (e.g., imported or uploaded to the system for training purposes). For instance, with respect to a driver license electronic document, a user can define the schema to extract values for data points that include: first name; second name; issue date; expiration date.

Operation 402 can be performed as part of a document extraction pipeline, such as a data streaming pipeline configured to receive as input a stream of electronic document files. The data streaming pipeline can be configured to output information extracted (e.g., values of data points) from electronic documents to a table of a data platform (e.g., insert extracted information into rows and columns of the table), such as a database table. As noted herein, one or more of the set of ML models can result in inaccurate information being extracted from a given electronic document, and, as such, human validation of extracted information can be beneficial in certain circumstances.

For some embodiments, a user that has context and domain knowledge about electronic documents, such as a business user (e.g., in the finance department responsible for reconciling the expense reports with receipts) or a domain specialist user, can train the set of ML models with the accuracy that they expect for extracting information from multiple electronic documents. The user can train the set of ML models by using a user interface to upload electronic documents for training purposes. Alternatively, the user can be someone who has no business context about the electronic documents to be processed. The set of ML models to be trained can include, without limitation, a zero-shot ML model, a foundational ML model, or a pre-trained user case model (e.g., a model pre-trained for “bank statement” electronic documents).

A user (e.g., a business user) can set up a document extraction processing pipeline by selecting an existing project or creating a new project. When the user creates a new project, electronic documents are imported into the project (e.g., from a local computing machine), and the imported set of electronic documents can be used by the user for exploration or training. The user can import additional electronic documents to the project for further training. To further train (e.g., fine-tune) the set of ML models for the user's information extraction purposes, the user can start defining (e.g., via a user interface) one or more data points to be extracted from electronic documents, such as by inputting (e.g., asking) questions in natural language using the current set of ML models to explore and annotate the electronic documents uploaded/imported for training. For example, a user can fine-tune the set of ML models by annotating a few electronic documents, and then starting the training process. The training process can then generate a new custom set of ML models (e.g., a single, trained ML model) that can be used with the project, and the binary of the set of ML models (e.g., binary of a single, trained ML model) can be persistently stored in association with the project. Eventually, values extracted from an electronic document, by the set of ML models, for the one or more data points can be stored into (e.g., ingested into) columns in a table (e.g., each data point goes into a designated column in a database table). Accordingly, each data point is defined by a name that conforms to a column identifier of a table.

At operation 404, the one or more hardware processors determine whether to select the current electronic document for human validation based on a random sample. For instance, a selection methodology can be implemented where operation 404 determines to randomly (e.g., based on a seed value) cause a human validation of the current electronic document. Such human validation by random sample can be useful in confirming that the set of ML models are working as expected, especially when the set of ML models are returned high confidence level/scores for data point values but the data point values are not accurate (e.g., due to data drift by the set of ML models, or a user made a change in training data and the set of ML models is not smart enough to adjust to the change and keeps giving high confidence level/score). The selection methodology could be configured to cause a certain percentage (e.g., threshold) of electronic documents processed to be submitted for human validation (e.g., 2% of all electronic documents processed).

In response to determining to select the current electronic document for human validation based on the random sample, the method 400 proceeds to operation 408, where the one or more hardware processors add the current electronic document to human validation queue. Depending on the embodiment, in response to determining to not select the current electronic document for human validation based on the random sample, the method 400 can proceed to operation 420 (not shown) or, alternatively, the method 400 can proceed to operation 406 (as shown). At operation 420, the one or more hardware processors store the set of values (e.g., extracted by the set of ML models at operation 402) to a table, such as a table of a data platform. As noted herein, the set of values can be stored in the table according to the schema (e.g., which can define data point to column mapping).

At operation 406, the one or more hardware processors determine whether to select the current electronic document for human validation based on the schema. For instance, if one or more of the set of values extracted from the electronic document do not match one or more related parameters described (e.g., defined by) the schema. For example, a value extracted for a data point from the electronic document can be determined not meet a parameter described by the schema if the value does not meeting an acceptable confidence level threshold (e.g., confidence level/score provided by the set of ML models for the value is less than the threshold) associated with the data point, or the value not satisfying a rule (e.g., a regex rule) associated with the data point (e.g., the rule is associated specifically with the data point).

In response to determining to select the current electronic document for human validation based on the schema, the method 400 proceeds to operation 408, where the one or more hardware processors add the current electronic document to a human validation queue (e.g., a hidden stage of the data platform). By adding a given electronic document to the human validation queue, the given electronic document can be flagged as the one that needs manual validation (e.g., with inference call response). Depending on the embodiment, a document extraction pipeline can stop or pause until an electronic document remains in the human validation queue to be validated by a human user.

In response to determining to not select the current electronic document for human validation based on the random sample, the method 400 proceeds to operation 420, where the one or more hardware processors store the set of values (e.g., extracted by the set of ML models at operation 402) to the table.

While FIG. 4 illustrates operation 404 being performed prior to operation 406, for some embodiments, the operations are transposed such that the determination of whether to select the current electronic document for human validation based on a random sample is performed after the current electronic document is not selected for human validation based on the schema.

After the current electronic document is added to the human validation queue (at operation 408), at operation 410, the one or more hardware processors provide a user with access to a human validation interface. For example, a user serving as a validator can log into a data platform and be directed to a human validation interface (e.g., document understanding graphical user interface) that includes a validation menu. A validator user can be responsible for validating data point values extracted by the set of ML models (e.g., predictions rendered by the set of ML models) and for manually correcting them where necessary. A validation user typically has knowledge about the business context of the electronic documents being processed.

To facilitate human validation, at operation 412, the one or more hardware processors cause presentation, by the human validation interface (e.g., a graphical user interface), of an individual electronic document from the human validation queue, where the individual electronic document is presented with a set of extracted data point values associated with the individual electronic document (e.g., those data point values extracted by the set of ML models from the individual electronic document prior to the individual electronic document being added to the human validation queue). For instance, the human validation interface can fetch one or more electronic documents from the human validation queue (e.g., associated hidden stage of the data platform) and present them (e.g., one at a time) to the user (e.g., validation user).

At operation 414, the one or more hardware processors receive, by the human validation interface, user feedback for the individual electronic document. In particular, by way of the human validation interface, the user can correct one or more of the extracted data point values, accept or reject the electronic document, or some combination thereof. For instance, the user (e.g., validation user) can iterate through one or more electronic documents fetched from the human validation queue and, for the individual electronic document currently presented (e.g., displayed in the human validation interface), can input one or more of the following: acceptance of the individual electronic document (e.g., indicating that extracted data point values are corrected and verified, and that the individual electronic document is ready to go to be ingested by/stored on a table); rejection of the individual electronic document (e.g., a majority of the extracted data point values are invalid and, as such, all of the extracted data point values are being rejected and will be prevented from storage in the table); or one or more correct values (e.g., answers) for one or more of the extracted data point values (e.g., manually adjust or replace the extracted data point values).

At operation 416, the one or more hardware processors adjust the ML model based on the user feedback. For instance, where the user rejects the individual electronic document at operation 414, or the user manually corrects invalid extracted data point values at operation 414, the rejection or the corrections can be used to adjust one or more parameters of the set of ML models (e.g., via adjustment of weights or negative reinforcement). However, additionally, if the user accepts the individual electronic document and it's associated the extracted data point values as-is, the user's acceptance can also result in an adjustment to the set of ML models (e.g., via positive reinforcement).

At operation 418, the one or more hardware processors store the set of extracted data point values in a table based on the user feedback. For instance, if the individual electronic document is accepted by the user at operation 414, or after all invalid extracted data point values are manually corrected by the user at operation 414, the set of extracted data point values is stored in the table (e.g., based on schema, which can map data points to column of the table). Additionally, the individual electronic document can be removed from the human validation queue. However, if the individual electronic document is rejected by the user at operation 414, none of the extracted data point values will be stored in the table.

At operation 420, the one or more hardware processors store the set of values (e.g., extracted by the set of ML models at operation 402) in the table.

FIG. 5 illustrates a diagrammatic representation of machine 500 in the form of a computer system within which a set of instructions may be executed for causing machine 500 to perform any one or more of the methodologies discussed herein, according to an embodiment. Specifically, FIG. 5 shows a diagrammatic representation of machine 500 in the example form of a computer system, within which instructions 516 (e.g., software, a program, an application, an applet, an app, or other executable code) for causing the machine 500 to perform any one or more of the methodologies discussed herein may be executed. For example, instructions 516 may cause machine 500 to execute any one or more operations of method 400 (or any other technique discussed herein). As another example, instructions 516 may cause machine 500 to implement one or more portions of the functionalities discussed herein. In this way, instructions 516 may transform a general, non-programmed machine into a particular machine 500 (e.g., the client device 114, the compute service manager 108, or a node in the execution platform 110) that is specially configured to carry out any one of the described and illustrated functions in the manner described herein. In yet another embodiment, instructions 516 may configure the client device 114, the compute service manager 108, and/or a node in the execution platform 110 to carry out any one of the described and illustrated functions in the manner described herein, which functions can be configured or performed by the document validator 132.

In alternative embodiments, the machine 500 operates as a standalone device or may be coupled (e.g., networked) to other machines. In a networked deployment, machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a smartphone, a mobile device, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

Machine 500 includes processors 510, memory 530, and input/output (I/O) components 550 configured to communicate with each other such as via a bus 502. In some embodiments, the processors 510 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 512 and a processor 514 that may execute the instructions 516. The term “processor” is intended to include multi-core processors 510 that may comprise two or more independent processors (sometimes referred to as “cores”) that may execute instructions 516 contemporaneously. Although FIG. 5 shows multiple processors 510, machine 500 may include a single processor with a single core, a single processor with multiple cores (e.g., a multi-core processor), multiple processors with a single core, multiple processors with multiple cores, or any combination thereof.

The memory 530 may include a main memory 532, a static memory 534, and a storage unit 536, all accessible to the processors 510 such as via the bus 502. The main memory 532, the static memory 534, and the storage unit 536 stores the instructions 516 embodying any one or more of the methodologies or functions described herein. The instructions 516 may also reside, completely or partially, within the main memory 532, within the static memory 534, within machine storage medium 538 of the storage unit 536, within at least one of the processors 510 (e.g., within the processor's cache memory), or any suitable combination thereof, during execution thereof by the machine 500.

The I/O components 550 include components to receive input, provide output, produce output, transmit information, exchange information, capture measurements, and so on. The specific I/O components 550 that are included in a particular machine 500 will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion and the grouping is in no way limiting. In various embodiments, the I/O components 550 may include output components 552 and input components 554. The output components 552 may include visual components (e.g., a display such as a plasma display panel (PDP), a light-emitting diode (LED) display, a liquid crystal display (LCD), a projector, or a cathode ray tube (CRT)), acoustic components (e.g., speakers), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures or other tactile input components), audio input components (e.g., a microphone), and the like.

Communication may be implemented using a wide variety of technologies. The I/O components 550 may include communication components 564 operable to couple the machine 500 to a network 580 or devices 570 via a coupling 582 and a coupling 572, respectively. For example, communication components 564 may include a network interface component or another suitable device to interface with network 580. In further examples, communication components 564 may include wired communication components, wireless communication components, cellular communication components, and other communication components to provide communication via other modalities. The device 570 may be another machine or any of a wide variety of peripheral devices (e.g., a peripheral device coupled via a universal serial bus (USB)). For example, as noted above, machine 500 may correspond to any one of the client devices 114, the compute service manager 108, or the execution platform 110, and device 570 may include the client device 114 or any other computing device described herein as being in communication with the network-based database system 102 or the cloud storage platform 104.

The various memories (e.g., 530, 532, 534, and/or memory of the processor(s) 510 and/or the storage unit 536) may store one or more sets of instructions 516 and data structures (e.g., software) embodying or utilized by any one or more of the methodologies or functions described herein. These instructions 516, when executed by the processor(s) 510, cause various operations to implement the disclosed embodiments.

As used herein, the terms “machine-storage medium,” “device-storage medium,” and “computer-storage medium” mean the same thing and may be used interchangeably in this disclosure. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate arrays (FPGAs), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various embodiments, one or more portions of the network 580 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, network 580 or a portion of network 580 may include a wireless or cellular network, and coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 516 may be transmitted or received over the network 580 using a transmission medium via a network interface device (e.g., a network interface component included in the communication components 564) and utilizing any one of several well-known transfer protocols (e.g., hypertext transfer protocol (HTTP)). Similarly, instructions 516 may be transmitted or received using a transmission medium via coupling 572 (e.g., a peer-to-peer coupling or another type of wired or wireless network coupling) to device 570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and includes digital or analog communications signals or other intangible media to facilitate communication of such software. Hence, the terms “transmission medium” and “signal medium” shall be taken to include any form of a modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

The various operations of example methods described herein may be performed, at least partially, by one or more processors that are temporarily configured (e.g., by software) or permanently configured to perform the relevant operations. Similarly, the methods described herein may be at least partially processor-implemented. For example, at least some of the operations of the disclosed methods may be performed by one or more processors. The performance of certain operations may be distributed among the one or more processors, not only residing within a single machine but also deployed across several machines. In some embodiments, the processor or processors may be located in a single location (e.g., within a home environment, an office environment, or a server farm), while in other embodiments the processors may be distributed across several locations.

Described implementations of the subject matter can include one or more features, alone or in combination as illustrated below by way of examples.

Example 1 is a system comprising: at least one hardware processor; and at least one memory storing instructions that cause the at least one hardware processor to perform operations comprising: processing a current electronic document, using a set of machine-learning models, to extract a set of values for a set of data points based on a schema, the schema describing the set of data points to be extracted from electronic documents; determining whether to select the current electronic document for human validation based on the schema; and in response to determining to select the current electronic document for human validation based on the schema, adding the current electronic document to a human validation queue.

In Example 2, the subject matter of Example 1 includes, wherein the operations comprise: in response to determining to not select the current electronic document for human validation based on the schema, storing the set of values in a table.

In Example 3, the subject matter of Example 2 includes, wherein the set of values is stored in the table according to the schema, the schema defining a mapping between one or more data points and one or more columns of the table.

In Example 4, the subject matter of Examples 1-3 includes, wherein the operations comprise: in response to determining to not select the current electronic document for human validation based on the schema, determining whether to select the current electronic document for human validation as a random sample based on a random sample value.

In Example 5, the subject matter of Example 4 includes, wherein the operations comprise: in response to determining to select the current electronic document for human validation as the random sample based on the random sample value, adding the current electronic document to the human validation queue 5 is missing parent: 6. The system of Example 4, wherein the operations comprise: in response to determining to not select the current electronic document for human validation as the random sample based on the random sample value, storing the set of values in a table.

In Example 6, the subject matter of Examples 4-5 includes, wherein the schema defines the random sample value.

In Example 7, the subject matter of Examples 1-6 includes, wherein the operations comprise: based on the current electronic document being added to the human validation queue, providing a user with access to a human validation interface.

In Example 7, the subject matter of Example 7 includes, wherein one or more user interface elements of the human validation interface are defined by the schema.

In Example 9, the subject matter of Examples 1-8 includes, wherein the operations comprise: causing presentation, by a human validation interface, of an individual electronic document from the human validation queue, the individual electronic document being presented with a set of extracted data point values associated with the individual electronic document.

In Example 9, the subject matter of Example 9 includes, wherein the operations comprise: receiving, by the human validation interface, user feedback for the individual electronic document.

In Example 10, the subject matter of Example 10 includes, wherein the operations comprise: storing the set of extracted data point values in a table based on the user feedback.

In Example 12, the subject matter of Examples 10-10 includes, wherein the operations comprise: adjusting at least one machine-learning model in the set of machine-learning models based on the user feedback.

In Example 13, the subject matter of Examples 10-12 includes, wherein the user feedback comprises at least one of: acceptance of the individual electronic document; rejection of the individual electronic document; or one or more correct values for the set of extracted data point values.

In Example 14, the subject matter of Examples 1-13 includes, wherein the determining whether to select the current electronic document for human validation based on the schema comprises: determining whether one or more values in the set of values do not match one or more related parameters described by the schema; in response to determining that at least one value in the set of values does not match a parameter described by the schema for the at least one value, determining to select the current electronic document for human validation; and in response to determining that all values in the set of values match related parameters described by the schema, determining to not select the current electronic document for human validation.

In Example 14, the subject matter of Example 14 includes, wherein the one or more related parameters comprise a parameter that defines a threshold for an acceptable confidence level provided by a select machine-learning model in connection with a select value extracted from a select electronic document.

In Example 16, the subject matter of Examples 14-14 includes, wherein the one or more related parameters comprise a parameter that defines a rule for a select value extracted from a select electronic document for a select data point.

In Example 17, the subject matter of Examples 1-16 includes, wherein the operations comprise: performing a training process to define at least a portion of the schema, the training process comprising a user asking one or more questions relating to a training set of electronic documents.

Example 18 is a machine-storage storage medium, the machine-storage medium including instructions that when executed by a machine, cause the machine to perform operations to implement of any of Examples 1-17.

Example 19 is a method to implement of any of Examples 1-17.

Although the embodiments of the present disclosure have been described concerning specific example embodiments, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is disclosed. Thus, although specific embodiments have been illustrated and described herein, it should be appreciated that any arrangement calculated to achieve the same purpose may be substituted for the specific embodiments shown. This disclosure is intended to cover any adaptations or variations of various embodiments. Combinations of the above embodiments, and other embodiments not specifically described herein, will be apparent to those of skill in the art, upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended; that is, a system, device, article, or process that includes elements in addition to those listed after such a term in a claim is still deemed to fall within the scope of that claim.

What is claimed is:

1. A system comprising:
at least one hardware processor; and
at least one memory storing instructions that cause the at least one hardware processor to perform operations comprising:
processing a current electronic document, using a set of machine-learning models, to extract a set of values for a set of data points based on a schema, the schema describing the set of data points to be extracted from electronic documents;
determining whether to select the current electronic document for human validation based on the schema; and
in response to determining to select the current electronic document for human validation based on the schema, adding the current electronic document to a human validation queue.

2. The system of claim 1, wherein the operations comprise:
in response to determining to not select the current electronic document for human validation based on the schema, storing the set of values in a table.

3. The system of claim 2, wherein the set of values is stored in the table according to the schema, the schema defining a mapping between one or more data points and one or more columns of the table.

4. The system of claim 1, wherein the operations comprise:
in response to determining to not select the current electronic document for human validation based on the schema, determining whether to select the current electronic document for human validation as a random sample based on a random sample value.

5. The system of claim 4, wherein the operations comprise:
in response to determining to select the current electronic document for human validation as the random sample based on the random sample value, adding the current electronic document to the human validation queue

6. The system of claim 4, wherein the operations comprise:
in response to determining to not select the current electronic document for human validation as the random sample based on the random sample value, storing the set of values in a table.

7. The system of claim 4, wherein the schema defines the random sample value.

8. The system of claim 1, wherein the operations comprise:
based on the current electronic document being added to the human validation queue, providing a user with access to a human validation interface.

9. The system of claim 8, wherein one or more user interface elements of the human validation interface are defined by the schema.

10. The system of claim 1, wherein the operations comprise:
causing presentation, by a human validation interface, of an individual electronic document from the human validation queue, the individual electronic document being presented with a set of extracted data point values associated with the individual electronic document.

11. The system of claim 10, wherein the operations comprise:
receiving, by the human validation interface, user feedback for the individual electronic document.

12. The system of claim 11, wherein the operations comprise:
storing the set of extracted data point values in a table based on the user feedback.

13. The system of claim 11, wherein the operations comprise:
adjusting at least one machine-learning model in the set of machine-learning models based on the user feedback.

14. The system of claim 11, wherein the user feedback comprises at least one of:
acceptance of the individual electronic document;
rejection of the individual electronic document; or
one or more correct values for the set of extracted data point values.

15. The system of claim 1, wherein the determining whether to select the current electronic document for human validation based on the schema comprises:
determining whether one or more values in the set of values do not match one or more related parameters described by the schema;
in response to determining that at least one value in the set of values does not match a parameter described by the schema for the at least one value, determining to select the current electronic document for human validation; and
in response to determining that all values in the set of values match related parameters described by the schema, determining to not select the current electronic document for human validation.

16. The system of claim 15, wherein the one or more related parameters comprise a parameter that defines a threshold for an acceptable confidence level provided by a select machine-learning model in connection with a select value extracted from a select electronic document.

17. The system of claim 15, wherein the one or more related parameters comprise a parameter that defines a rule for a select value extracted from a select electronic document for a select data point.

18. The system of claim 1, wherein the operations comprise:
performing a training process to define at least a portion of the schema, the training process comprising a user asking one or more questions relating to a training set of electronic documents.

19. A method comprising:
processing, by one or more hardware processors, a current electronic document, using a set of machine-learning models, to extract a set of values for a set of data points based on a schema, the schema describing the set of data points to be extracted from electronic documents;
determining, by the one or more hardware processors, whether to select the current electronic document for human validation based on the schema; and
in response to determining to select the current electronic document for human validation based on the schema, adding, by the one or more hardware processors, the current electronic document to a human validation queue.

20. The method of claim 19, comprising:
in response to determining to not select the current electronic document for human validation based on the schema, storing the set of values in a table.

21. The method of claim 20, wherein the set of values is stored in the table according to the schema, the schema defining a mapping between one or more data points and one or more columns of the table.

22. The method of claim 19, comprising:
in response to determining to not select the current electronic document for human validation based on the schema, determining whether to select the current electronic document for human validation as a random sample based on a random sample value.

23. The method of claim 22, comprising:
in response to determining to select the current electronic document for human validation as the random sample based on the random sample value, adding the current electronic document to the human validation queue

24. The method of claim 22, comprising:
in response to determining to not select the current electronic document for human validation as the random sample based on the random sample value, storing the set of values in a table.

25. The method of claim 22, wherein the schema defines the random sample value.

26. The method of claim 19, comprising:
based on the current electronic document being added to the human validation queue, providing a user with access to a human validation interface.

27. The method of claim 26, wherein one or more user interface elements of the human validation interface are defined by the schema.

28. The method of claim 19, comprising:
causing presentation, by a human validation interface, of an individual electronic document from the human validation queue, the individual electronic document being presented with a set of extracted data point values associated with the individual electronic document.

29. The method of claim 28, comprising:
receiving, by the human validation interface, user feedback for the individual electronic document.

30. A machine-storage medium, the machine-storage medium including instructions that when executed by a machine, cause the machine to perform operations comprising:
processing a current electronic document, using a set of machine-learning models, to extract a set of values for a set of data points based on a schema, the schema describing the set of data points to be extracted from electronic documents;
determining whether to select the current electronic document for human validation based on the schema; and
in response to determining to select the current electronic document for human validation based on the schema, adding the current electronic document to a human validation queue.
